(19) United States
(12) Patent Application Publication
(10) Pub. No.: US 2024/0265373 A1
(43) Pub. Date: Aug. 8, 2024

(54) ACCOUNTABLE DECENTRALIZED ANONYMOUS PAYMENTS

(71) Applicant: VMware, Inc., Palo Alto, CA (US)

(72) Inventors: Alin Tomescu, Palo Alto, CA (US); Adithya Bhat, West Lafayette, IN (US); Ittai Abraham, Herzliya (IL); Guy Gueta, Herzliya (IL); Binyamin Pinkas, Tel Aviv (IL); Avishay Yanai, Herzliya (IL)

(21) Appl. No.: 18/160,110

(22) Filed: Jan. 26, 2023

(51) Int. Cl. G06Q 20/36; G06Q 20/38; G06Q 20/40

(52) U.S. Cl. CPC G06Q 20/3678; G06Q 20/389; G06Q 20/4014

(57) ABSTRACT

Disclosed are examples of accountable decentralized anonymous payment systems and methods. One such method comprises storing, in a digital wallet, a digital coin that has been signed by a bank computing device; rerandomizing the digital coin and a coin signature to produce a new version of the digital coin that is anonymous with respect to an owner of the digital coin; sending the new version of the digital coin to a recipient computing device; computing a nullifier for the new version of the digital coin using a pseuodorandom function over a serial number of the digital coin; sending the nullifier for the new version of the digital coin to the bank computing device; and providing the bank computing device a zero knowledge proof that a value of the nullifier for the new version of the digital coin is correct and is the same as a nullifier of the digital coin.

### BACKGROUND

Electronic cash (ecash) schemes have received significant attention since Chaum's foundational work on blind signatures. The recent advent of cryptocurrencies has further increased interest in improving the anonymity and efficiency of ecash. Indeed, this fruitful line of work led to decentralized anonymous payment (DAPs) schemes that hide all transaction details, including senders, recipients, and amounts.

Unfortunately, the unconditional anonymity of DAPs is often a cause for concern, due to illicit activities as well as fears of a future regulatory crackdown. Furthermore, emerging applications such as centrally-banked digital currencies (CBDC) demand some degree of accountability to balance anonymity with certain restrictions. Thus, there is a need for new developments and improvements in accountable payment systems.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows an exemplary accountable decentralized anonymous payments (aDAP) system in accordance with embodiments of the present disclosure.

FIG. 2 illustrates an example of a server or computing device that can be utilized for systems and methods of the present disclosure.

FIG. 3 illustrates an example of a client or computing device can be utilized for systems and methods of the present disclosure.

FIG. 4 shows an example overview of an untraceable transaction (UTT) using an exemplary aDAP system of FIG. 1 in accordance with various embodiments of the present disclosure.

FIG. 5 shows an example overview of an anonymous-but-unaccountable UTT transaction in accordance with the present disclosure.

### DETAILED DESCRIPTION

Disclosed are examples of accountable decentralized anonymous payment systems and methods. While decentralized anonymous payment (DAPs) schemes hide all transaction details, including senders, recipients, and amounts, accountability is needed for certain applications. Thus, progress has been made both on designing and microbenchmarking accountable decentralized anonymous payments (aDAPs), but there has been little to no progress on building and evaluating a Byzantine fault tolerant aDAP system. Thus, systems and methods of the present disclosure present an accountable decentralized anonymous payment scheme to balance accountability and privacy. As such, systems and methods of the present disclosure seek to emulate physical cash, which offers complete anonymity for small payments and auditability for large payments (in many jurisdictions). Accordingly, transactions are fully anonymous, hiding senders, recipients and amounts. While, exemplary systems and methods of the present disclosure balance this with accountability, through so-called anonymity budgets. Specifically, in various embodiments, each user is limited to only send up to B coins anonymously per month, which is believed to reasonably balance privacy with accountability. Exemplary implementations are optimized for performance, such as by utilizing efficient building blocks like E-protocols and rerandomizable signatures. To the best of the inventors' knowledge, the use of rerandomizable signatures over rerandomizable commitments and a E-protocol for proving correctness of “nullifiers” of spent coins are both novel building blocks that provide concrete efficiency gains relative to previous solutions.

In an exemplary embodiment, an aDAP system (also referred to as an untraceable transaction (UTT) system) combines decentralized trust, accountable privacy, and scalability. Accordingly, in various embodiments, UTT obtains decentralized trust by implementing the bank (and other authorities) via distributed computing devices or servers using threshold cryptography and Byzantine Fault Tolerance such that the security and privacy guarantees are maintained. Furthermore, fault tolerance mechanisms are integrated with cryptography to allow parallel processing, vertical scaling, and sharding.

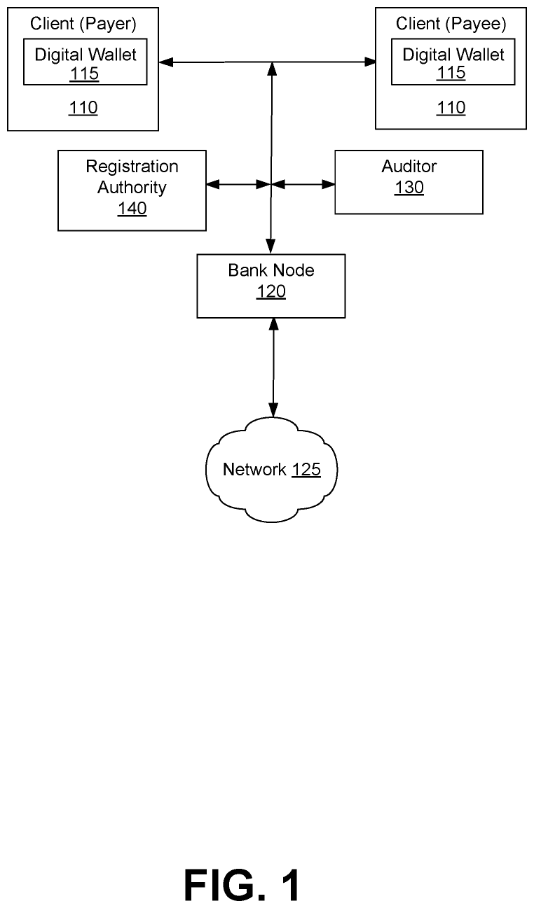

Referring now to FIG. 1, an exemplary aDAP system 100, in accordance with various embodiments of the present disclosure, includes (1) client computing devices 110 of users, such as payers and payees, who want to transact by exchanging digital currency (“coins”), (2) a bank node 120 within a distributed ledger network 125 (e.g., blockchain network) which issues new coins and blindly validates transactions between users, (3) an auditor computing device or server 130 that grants users anonymity budgets and audits transactions when users run out of budget, and (4) a registration authority (RA) computing device 140, which is responsible for registering users for the aDAP system 100.

In various embodiments, the bank 120 has a rerandomizable signature keypair (bsk, bvk) which it uses to sign new coins. The bank's state consists of a ledger of valid transactions and a nullifier list which keeps track of spent or “nullified” coins. Additionally, users store coins in a digital wallet application 115 of their client computing device 110. Each user has a public identifier pid (e.g., phone number, email address, or national identity number) and two secrets: a pseudo-random function (PRF) key s, which allows them to spend their coins, and a decryption secret key dsk, which allows them to receive coins.

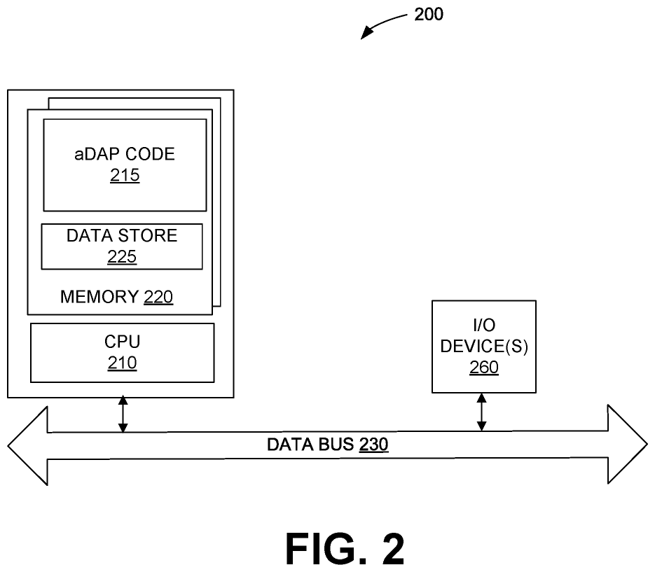

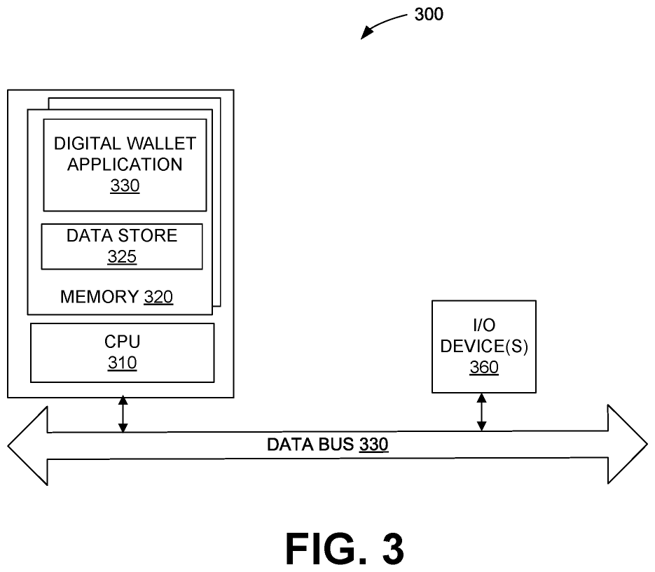

FIGS. 2 and 3 illustrate example computing devices in the aDAP system 100 according to various embodiments of the present disclosure. In particular, FIG. 2 illustrates an example of a server 200 or computing device, such as any one of the servers 120, 130, or 140 illustrated in FIG. 1. The embodiment of the computing device 200 illustrated in FIG. 2 is for illustration only, and the computing devices 120, 130, 140 of FIG. 1 could have the same or a similar configuration. Computing device 200 includes at least one processor, e.g., a central processing unit (CPU), 210 coupled to memory elements 220 through a data bus 230 or other suitable circuitry. Computing device 200 stores program code within memory elements 220. Processor 210 executes a program code accessed from memory elements 220 via the data bus 230. It should be appreciated that computing device 200 can be implemented in the form of any system including a processor and memory that is capable of performing the functions described within this disclosure.

Memory elements 220 include one or more physical memory devices such as, for example, a local memory and one or more storage devices. Local memory refers to random access memory (RAM) or other non-persistent memory device(s) generally used during actual execution of the program code. Storage device may be implemented as a hard disk drive (HDD), solid state drive (SSD), or other persistent data storage device. Computing device 200 may also include one or more cache memories (not shown) that provide temporary storage of at least some program code in order to reduce the number of times program code must be retrieved from storage device during execution.

Stored in the memory 220 are both data and several components that are executable by the processor 210. In particular, stored in the memory 220 and executable by the processor 210 are applicable aDAP code 215 for performing functions related to the bank 120, auditor 130, and/or registration authority 140 roles or functionality as described in the present disclosure. Also stored in the memory 220 may be a data store 225 and other data related to the bank 120, auditor 130, and/or registration authority 140 roles as described in the present disclosure. In addition, an operating system may be stored in the memory 220 and executable by the processor 210. Various applications or other functionality can be executed in the computing environment 200 according to various examples.

Input/output (I/O) devices 260 such as a keyboard, a display device, and a pointing device may optionally be coupled to computing device 200. The I/O devices may be coupled to computing device 200 either directly or through intervening I/O controllers. A network adapter may also be coupled to the computing device to enable the computing device to become coupled to other systems, computer systems, remote printers, and/or remote storage devices through intervening private or public networks. Modems, cable modems, Ethernet cards, and wireless transceivers are examples of different types of network adapter that may be used with the computing device 200.

The distributed ledger network 125 can include, for example, a server computer or any other system providing computing capability. Alternatively, the distributed ledger network 125 can employ a plurality of computing devices that can be arranged, for example, in one or more server banks or computer banks or other arrangements. These computing devices can be located in a single installation or can be distributed among many different geographical locations. For example, the distributed ledger network 125 can include a plurality of computing devices that together can include a blockchain network, a grid computing resource, or any other distributed computing arrangement. In some cases, the distributed ledger network 125 can correspond to an elastic computing resource where the allotted capacity of processing, network, storage, or other computing-related resources can vary over time.

FIG. 3 illustrates an example client device 300 according to embodiments of the present disclosure. The embodiment of the client device 300 illustrated in FIG. 3 is for illustration only, and the client devices 110 of FIG. 1 could have the same or a similar configuration. As shown in FIG. 3, the client device 300 includes a at least one processor, e.g., a central processing unit (CPU), 310, memory elements 320, a data store 325, a data bus 330 or other suitable circuitry. Client device 300 stores program code within memory elements 320. Stored in the memory 320 are both data and several components that are executable by the processor 310. In particular, stored in the memory 320 and executable by the processor 310 are digital wallet application code for performing functions related to conducting transactions (e.g., transferring or receiving digital coins) in relation to an exemplary aDAP system 100 of the present disclosure. Various applications or other functionality can be executed in the computing environment 300 according to various examples.

It should be appreciated that the client device 300 can be implemented in the form of any system including a processor and memory that is capable of performing the functions described within this disclosure. Input/output (I/O) devices 360 such as a keyboard, a display device, and a pointing device may optionally be coupled to computing device 300. The I/O devices may be coupled to computing device 300 either directly or through intervening I/O controllers. A network adapter may also be coupled to the client device to enable the client device to become coupled to other systems, computer systems, remote printers, and/or remote storage devices through intervening private or public networks. Modems, cable modems, Ethernet cards, and wireless transceivers are examples of different types of network adapter that may be used with the client device 300.

The client device 110 is representative of a plurality of client devices that can participate in an exemplary aDAP system 100. The client device 110 can include a personal computer (e.g., a desktop computer, a laptop computer, or similar device), a mobile computing device (e.g., personal digital assistants, cellular telephones, smartphones, web pads, tablet computer systems, and similar devices), or other devices with like capability. The client device 110 can be configured to execute various applications such as one or more client applications. The client application could be a web browser and the user interface could include a web page rendered within a browser window that is capable of conducting transactions within the aDAP system 100.

As illustrated in FIG. 1, an accountable DAP has several actors: banks 120, auditors 130, and registration authorities 140. To avoid compromise and to bootstrap trust, an exemplary aDAP system 100 of the present disclosure decentralizes these actors via a Byzantine-fault tolerance (BFT) environment and relies on (1) pseudo random functions, (2) rerandomizable signatures over commitments, (3) E-protocols, (4) anonymous identity-based encryption and (5) zero-knowledge range proofs as key building blocks to achieve a scalable generalized ecash solution.

For anonymity budgets to work, creating fake digital identities for users (i.e., Sybil attacks) must be difficult. Otherwise, malicious users can artificially increase their anonymity budget. Therefore, an exemplary aDAP scheme of the present disclosure can deploy an identity verification process (via registration authority 140) that prevents attackers from registering multiple times.

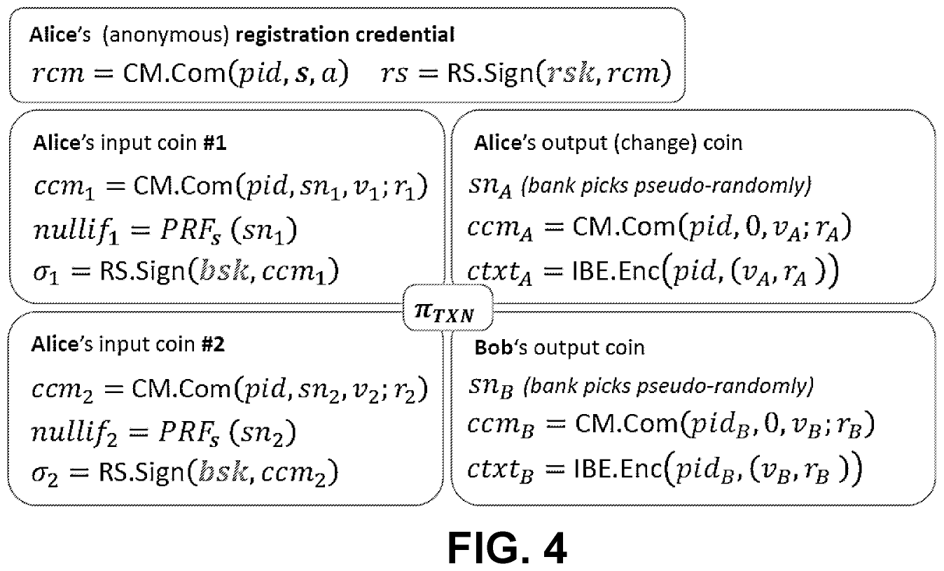

Next, FIG. 4 presents an example overview of an untraceable transaction (UTT) using an exemplary aDAP system 100 between a client device 110 of a payer user (Alice) and a client device 110 of payee user (Bob). Accordingly, in the present disclosure, we represent a coin as a cryptographic commitment ccm to three values: the owner's public identifier, denoted by pid, the value of the coin v and a serial number sn used to prevent double spends: i.e., ccm=CM.Com(pid, sn, v). To issue the coin, the bank 120 digitally signs its commitment as 6=RS.Sign(bsk, ccm), where bsk is the bank's secret key for a rerandomizable signature scheme. In various embodiments, the bank is part of a Byzantine fault tolerant (BZT) distributed ledger network 125 and bsk is secret-shared amongst the BFT replica nodes of the distributed ledger network 125.

When spending her coin, a user Alice (at a client device 110) does not reveal her original ccm with signature σ, which the bank issued and would recognize. Instead, Alice picks randomizers Δr and Δu and rerandomizes her coin and its signature as ccm′=CM.Rerand(ccm; Δr) and σ′=RS.Rerand(σ; Δr, Δu). As a result, the bank 120 can no longer link the old coin with this newly rerandomized version of the coin, which guarantees anonymity, but the rerandomized signature will verify on the rerandomized commitment.

At the same time, Alice needs to anonymously indicate in the transaction that she is sending her coin to Bob (at a client device 110) with pidB. For this, Alice creates a commitment [symbol] =CM.Com(pid_{B}, 0, v) to Bob's future coin, excluding its serial number. The bank will homomorphically add in a unique serial number sn_{B} as ccm_{B}= [symbol] .CM.Com(0,sn_{B},0) and sign, assuming the transaction passes various checks such as no double spends, authorization, and value preservation. Importantly, Alice's transaction encrypts the value v for Bob using an identity-based encryption (IBE). Although Bob's sn_{B} is included publicly in the transaction, Bob will never have to reveal it again, which preserves anonymity. In certain embodiments, the unique serial number selected by the bank can be, but is not limited to, a random number.

To prevent double spends, Alice will derive a unique nullifier for her coin. The bank 120 can then check a nullifier list for which nullifiers are spent. Since Alice's coin serial number is public, having been previously picked by the bank 120, Alice cannot anonymously reveal the sn itself as the nullifier. Instead, Alice will compute the nullifier as a pseudo-random function (PRF) over the sn. One key contribution here is a faster mechanism for Alice to prove (and for the bank 120 to verify, based on Alice's committed pid) the correctness of her nullifier.

Clearly, only Alice should be able to spend her coin. However, since coin serial numbers are bank-picked and Alice's pid and coin value are guessable, this begs the question: “What secret information can Alice use to authorize the transfer of her coin?” Here, we leverage Alice's secret knowledge of her PRF key, which Alice can use to implicitly sign her transaction as she proves the correctness of her nullifier (e.g., via the Fiat-Shamir transform]).

Lastly, when sending her coin of value v to Bob's client device, Alice's client device could maliciously create a coin commitment for Bob with value v′>v, thereby creating money out of thin air. To prevent this, Alice proves to the bank 120, in zero-knowledge, that the input value v and the output value v′ are the same.

If Alice has coins of value v₁ and v₂, she should be able to send Bob v_{B} coins and give herself change v_{A}=(v₁+v₂)−v_{B}. This 2-to-2 transaction type depicted in FIG. 4, where Alice spends two input coins and creates two new output coins, is central to the exemplary design of the present disclosure. But Alice must now prove value preservation, or that v₁+v₂=v_{A}+v_{B}. Otherwise, as explained before, Alice can maliciously create coins out of thin air. In addition, as [symbol] shown by previous works, when values are encoded as elements of [symbol] , proving that the equality above holds modulo p is not sufficient, so Alice gives an additional zero-knowledge range proof (ZKRP) on the (committed) output values v_{A} and v_{B}.

To ensure that each user can only send up to B coins per month, a single budget coin of denomination B is issued to each user every month by auditor 130. The transaction is changed to additionally take this budget coin as its third input and give budget coin change as its third output. Crucially, the transaction proves (also via a range proof) that the amount transferred to Bob does not exceed the input budget amount.

To prevent Sybil attacks, a registration authority (RA) 140 is configured to allow new users into the system 100 after they pass an identity verification process. Specifically, each user is given an anonymous registration credential rcm signed under the RA's secret key rsk, also using a rerandomizable signature scheme. This credential anonymously links a user's pid with their PRF key s. In addition to anonymously proving that a coin's owning user is registered, the credential also helps prove correctness of nullifiers by anonymous linking a coin's pid with the PRF key s used to compute said nullifier.

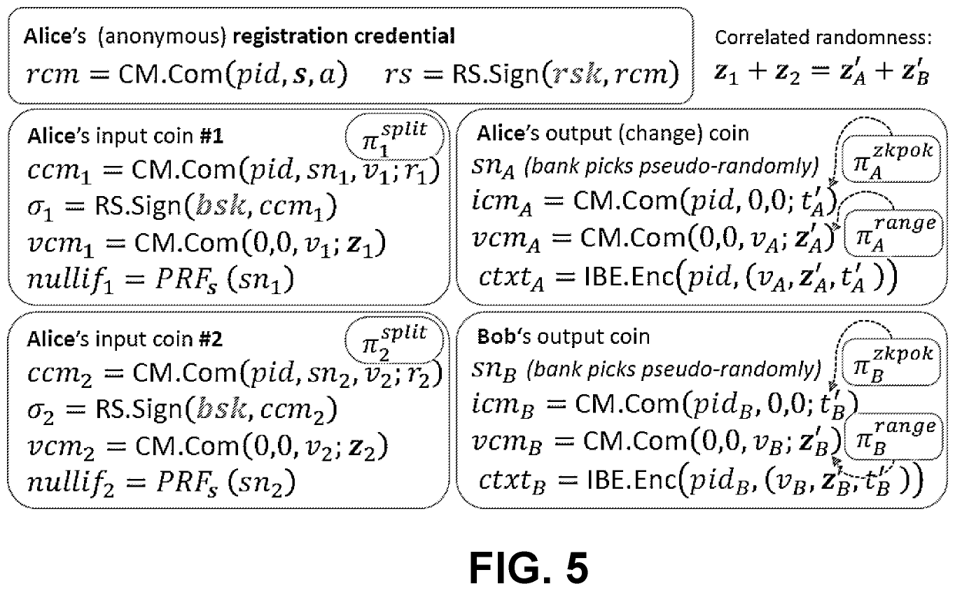

While FIG. 4 provides a high-level design of an exemplary system of the present disclosure, FIG. 5 shows a lower-level design built from commitments, rerandomizable signatures, E-protocols and range proofs. In the following discussion, we will focus on how these building blocks fit together.

As discussed, an exemplary aDAP system 100 includes (1) client devices 110 of users, who want to transact, (2) a bank 120, which issues new coins and blindly validates transactions, (3) an auditor 130 that grants users anonymity budgets and audits transactions when users run out of budget, and (4) a registration authority (RA) 140 that is responsible for registering users to prevent Sybil attacks on anonymity budgets.

Referring now to FIG. 5, a more fine-grained view of an anonymous-but-unaccountable UTT transaction is provided (in comparison to FIG. 4). In brief, Alice is sending two coins of values v₁ and v₂ and giving v_{B} coins to Bob and v_{A} coins back to herself. Alice provably “splits” each input coin i into a nullifᵢ and a value commitment vcmᵢ via a splitproof πᵢ^{split}. For each recipient j∈{A,B}, Alice creates output value commitments vcmⱼ with range proofs and uses correlated randomness to argue that v₁+v₂=v_{A}+v_{B}. Alice also creates identity commitments icmⱼ (with zero-knowledge proofs of knowledge (ZKPoKs) of opening), which the bank 120 combines with their corresponding vcmⱼ and serial number snⱼ to obtain an output coin commitment and sign it. In doing so, the bank 120 has a rerandomizable signature keypair (bsk, bvk) which it uses to sign new coins. The bank's state consists of a ledger of valid transactions and a nullifier list which keeps track of spent or “nullified” coins.

Users store coins in their wallet 115, where each user has a public identifier pid (e.g., phone number, email address or national identity number) and two secrets: a PRF key s, which allows them to spend their coins, and a decryption secret key dsk, which allows them to receive coins.

The Registration authority (RA) 140 prevents attackers from arbitrarily creating fake user identities in the aDAP system and artificially increasing their anonymity budget. The RA 140 registers new users who passed an identity verification process. Specifically, it issues anonymous credentials using a rerandomizable signature key-pair (rsk, rvk). Furthermore, the RA 140 manages an IBE key-pair (msk, mpk) and issues each user their dsk.

Each user receives their anonymity budget from the auditor 130, who signs budget coins, using a rerandomizable signature key-pair (ask, apk), which the bank 120 also knows. When a user “runs out of anonymity budget,” they can still create transactions that are anonymous to the bank 120, but not to the auditor 130, who must clear them based on a customizable auditing policy. In various embodiments, the auditor 140 may have a governance mechanism that allows it to change its anonymity budget policy.

To register, a user with pid must first pass an identity verification process. Then, the RA 140 can issue them a decryption secret key dsk and a registration credential consisting of a signature rs on a registration commitment rcm to their pid and PRF key s=s₁+s₂, where the user picks s₁ and the server picks s₂. First, the user lets rcm₁←CM.Com([0, s₁]; a), where (a, s₁)← [symbol] ₚ² and sends (pid, rem₁) to the RA 140, together with a ZKPoK of the opening [0, s₁]. Second, the RA 140 picks s₂←$ [symbol] ₚ, and lets:

$${rcm}_{2} ← CM . Com ( [ pid , {s}_{2} ] ; 0 ) \qquad ( 1 )$$

$$rcm ← {rcm}_{1} \cdot {rcm}_{2} = CM . Com ( [ pid , s ] , a ) \qquad ( 2 )$$

$$rs ← RS . Sign ( rsk , rcm ; b ) , where b ← {\$ℤ}_{p} \qquad ( 3 )$$

$$dsk ← IBE . Extract ( msk , pid ) \qquad ( 4 )$$

Third, the RA 140 sends (rcm, rs, dsk, s₂) to the user's client device 110 who computes his PRF key as s=s₁+s₂. Dsk and s₂ are privately-sent (e.g., via TLS). Note that while the RA 140 learns who is registering, it does not learn their PRF key s.

Whenever a user's client device 110 asks for their monthly budget, they must present their registration credential (rcm, rs) and provably reveal their committed pid, which allows the auditor 130 to check if that pid has already been issued budget. This prevents Sybil attacks on anonymity budgets. Even though users reveal their pid's during budget issuance, anonymity could be preserved if users instead proved (in ZK) that their pid has not already been issued budget.

A commitment is made to a coin owner's pid, its value v and serial number sn as:

$$ccm = CM . Com ( [ pid , sn , v ] ; r ) , where r ← {\$ℤ}_{p} \qquad ( 5 )$$

Since, in certain embodiments, the bank 120 will pick the sn pseudo-randomly, transactions (TXNs) maintain privacy by revealing a nullifier (i.e., a PRF over the sn) instead of the publicly-known sn. The bank 120 computes a coin signature a directly over the commitment ccm, which hides all coin details from the bank 120:

$$σ = RS . Sign ( bsk , ccm ; u ) , where u ← {\$ℤ}_{p} \qquad ( 6 )$$

This way, anyone can verify if a committed coin was validly-issued by the bank 120 via RS.Ver(bvk, ccm, a).

A key ingredient of the privacy-preserving design is that a user's client device 110 (e.g., wallet application 115) can take an old coin (ccm, a), which the bank 120 knows of, and rerandomize it as a new coin (ccm′, σ′). This way, if a transaction spends the rerandomized coin (ccm′, σ′), the bank 120 cannot tell that this coin is actually spending the old coin. Specifically, the user's client device (e.g., wallet application 115) randomly picks (Δr, Δu)←$ [symbol] ₚ² and rerandomizes as:

$${ccm}^{′} ← CM . Rerand ( ccm ; Δ r ) \qquad ( 7 )$$

$${σ}^{′} ← RS . Rerand ( σ ; Δ r , Δ u )$$

Importantly, the new σ′ signature still verifies against the rerandomized ccm.

Since serial numbers are picked by (and known to) the bank 120, coins cannot be anonymously marked as spent by their serial number. Instead, when including a coin (ccm, σ) in a transaction, the owner reveals a nullifier computed as a PRF over the coin's serial number: nullif=PRFs(sn). It will be useful to additionally reveal a separate value commitment vcm=CM.Com([0, 0, v]; z), where z←$ [symbol] ₚ. Importantly, the owner argues correctness of nullif and vcm by proving, in zero-knowledge, that the following relation Rₛₚₗᵢₜ(ccm, rcm, nullif, vcm; pid, sn, v, r, s, a, z) holds:

$$( \begin{matrix}ccm = CM . Com ( [ pid , sn , v ] ; r ) ∧ \\ rcm = CM . Com ( [ pid , s ] ; a ) ∧ \\ nullif = {PRF}_{s} ( sn ) ∧ \\ vcm = CM . Com ( [ 0 , 0 , v ] ; z )\end{matrix} ) \qquad ( 8 )$$

We call this a splitproof and denote it by π^{split}.

FIG. 5 illustrates an anonymous-but-unaccountable transactions format. Let's consider Alice as having pid_{A}, PRF key s_{A} and registration credential (rcm, rs) with two coins (pid_{A}, snᵢ, v₁)_{i∈{1,2}}, committed and signed as (ccmᵢ, σᵢ)_{iE{1,2}}. Alice wants to pay v_{B} coins to Bob with pid_{B} and get v_{A} coins back as change, of course subject to v₁+v₂=v_{A}+v_{B}. We incrementally design an anonymous-but-unaccountable transaction format for this task below.

Step 1: Input commitments—First, Alice's client device 110 includes her anonymous registration credential in a transaction tx. Second, she includes her signed input coin commitments ccmᵢ, their nullifiers, and separate value commitments vcmᵢ=CM.Com([0, 0, v₁]; zᵢ) with randomness zᵢ she picked. So far, the transaction is:

$$tx = ( rcm , rs ) , {〈 ( {ccm}_{i} , {σ}_{i} ) , {vcm}_{i} , {nullif}_{i} , {π}_{i}^{split} 〉}_{i ∈ \{ 1 , 2 \}} \qquad ( 9 )$$

Importantly, Alice's client device 110 rerandomized her anonymous credential, as well as her coins and their signatures (via CM.Rerand and RS.Rerand) so that neither the bank 120 nor the RA 140 recognizes them from when they issued them in the past. Alice's client device 110 will also need to anonymously prove that she owns her coins, which she will actually do by implicitly signing tx via her π^{split}.

Step 2: Output commitments—Next, Alice needs to anonymously indicate she is sending v_{B} coins to Bob with pid_{B} and v_{A} coins to herself back as change. For this, Alice picks randomness (t′ⱼ, z′ⱼ) and creates separate output value commitments and identity commitments to the amount and identity of each recipient j∈{A,B}:

$${icm}_{j} = CM . Com ( [ {pid}_{j} , 0 , 0 ] ; {t}_{j}^{′} ) \qquad ( 10 )$$

$${vcm}_{j} = CM . Com ( [ 0 , 0 , {v}_{j} ] ; {z}_{j}^{′} ) \qquad ( 11 )$$

Alice's client device 110 also uses IBE to encrypt recipient j's coin value and randomness, which they will need when receiving her payment:

$${ctxt}_{j} = IBE . Enc ( mpk , {pid}_{j} , ( {v}_{j} , {z}_{j}^{′} , {t}_{j}^{′} ) ) \qquad ( 12 )$$

Importantly, the anonymous IBE scheme guarantees that ciphertext ctxtⱼ does not leak anything about the recipient pidⱼ. Next, Alice computes a ZKPoK πⱼ^{zkpok} of the opening [pidⱼ, 0, 0] of each icmⱼ and a ZK range proof πⱼ^{range}=ZKRP.Prove(vⱼ, z′ⱼ), for each vcmⱼ. These will be used to ensure Alice does not create coins out of thin air. The transaction is now extended as:

$$tx = \{ \begin{matrix}( rcm , rs ) , {〈 ( {ccm}_{i} , {σ}_{i} ) , {vcm}_{i} , {nullif}_{i} , {π}_{i}^{split} 〉}_{i ∈ [ 2 ]} \\ {〈 {icm}_{j} , {π}_{j}^{zkpok} , {vcm}_{j} , {π}_{j}^{range} , {ctxt}_{j} 〉}_{j ∈ \{ A , B \}}\end{matrix} \qquad ( 13 )$$

Step 3: Value preservation—Alice must prove that v₁+v₂=v_{A}+v_{B}, or value preservation; otherwise, she could create coins out of thin air by inflating her change amount v_{A}. For this, an efficient approach based on homomorphic commitments with correlated randomness can be used. Specifically, since Alice is the one who picks the randomness of the value commitments, she can correlate it so that z₁+z₂=z′_{A}+z′_{B}. As a result, the homomorphic properties of the commitment can be used to verify value preservation:

$${vcm}_{1} \cdot {vcm}_{2} = {vcm}_{A} \cdot {vcm}_{B} ⇔ \qquad ( 14 )$$

$$CM . Com ( [ 0 , 0 , {v}_{1} + {v}_{2} ] ; {z}_{1} + {z}_{2} ) = CM . Com ( [ 0 , 0 , {v}_{A} + {v}_{B} ] ; {z}_{A}^{′} + {z}_{B}^{′} ) ⇒ \qquad ( 15 )$$

$${v}_{1} + {v}_{2} ≡ {v}_{A} + {v}_{B} ( mod p ) \qquad ( 16 )$$

Here, p is the prime order of our bilinear groups. However, note that the equality above holding (mod p) is actually not enough: a malicious Alice could set v_{B}=(v₁+v₂)+1 and v_{A}=p−1. This gives v_{A}+v_{B}=(v₁+v₂)+p ≡(v₁+v₂) (mod p), yet Alice has maliciously created p additional coins out of thin air. This is why each output value commitment vcmⱼ comes with a range proof πⱼ^{range} which proves that, when viewed as a positive integer, vⱼ<2^{N} (i.e., a predefined maximum number of coins in the system).

Step 4: Authorization (and TXN non-malleability)—Clearly, only Alice, who knows the PRF key s_{A} associated with her pid_{A} should be able to spend her coins. Furthermore, an adversary should not be able to maul Alice's TXN and change the recipients or amounts. This is ensured by using a zero-knowledge signature of knowledge (ZKSoK) as the splitproof rather than a plain ZKAoK. As a result, each input's splitproof πᵢ^{split} implicitly signs all the outputs, which proves that Alice is authorized to spend that input's coin and prevents TXN mauling. The signing key can be thought of as Alice's PRF key s_{A} (and all other secrets in Eq. 8), which only she knows.

In the following discussion, we explain how the bank 120 (1) validates our anonymous-but-unaccountable transactions, (2) issues new coins, and (3) how recipients fetch them.

Validating TXNs—Given Alice's tx from Eq. 13, the bank first checks that the sender's registration credential is valid via RS.Ver(rvk, rcm, rs). Importantly, since the bank 120 verifies this signature against the (rerandomized) registration commitment, the bank 120 learns nothing about Alice's identity. Second, the bank checks that each coin was validly issued via RS.Ver(bvk, ccmᵢ, σᵢ), Λi∈[2]. Third, the bank checks that the split relation Rsplit(ccmᵢ, rcm, nullifᵢ, vcmᵢ) from Eq. 8 holds via πᵢ^{split} for each i∈[2]. This implicitly verifies Alice's signature on the whole transaction, without leaking Alice's identity as the sender.

Fourth, the bank 120 parses the tx's input (vcmᵢ)_{i∈[2]} and output (vcmⱼ)_{j∈{A,B}} and checks value preservation holds modulo p as per Eq. 14. Then, the bank checks each output's range proof, which implicitly proves knowledge of an opening [0, 0, vⱼ] for vcmⱼ. (Note that input vcmᵢ's do not need a range proof: since input coins were validly issued, they can safely be assumed to be “in range.”)

Fifth, the bank 120 checks, via πⱼ^{zkpok} that each icmⱼ is of the form [pidⱼ, 0, 0] for some secret pidⱼ. Lastly, the bank 120 ensures all nullifᵢ's are not in its nullifier list. If so, the bank 120 adds the nullifiers to the set and adds tx to the ledger of valid TXNs.

The bank is now ready to blindly issue new coins for the recipients, without learning the amounts or identities of the recipients. First, the bank 120 uniquely (e.g., pseudo-randomly) picks serial numbers snⱼ=Hsn(tx∥j) for each output coin j∈{A,B}, where Hsn is a collision-resistant hash function (CRHF). Since the bank 120 verified each (πⱼ^{zkPok}, πⱼ^{range}), it can safely compute the jth output coin commitment as:

$$\begin{matrix}{ccm}_{j} & = & {icm}_{j} \cdot CM . Com ( [ 0 , {sn}_{j} , 0 ] ; 0 ) \cdot {vcm}_{j} & ( 17 ) \\ & = & CM . Com ( [ {pid}_{j} , {sn}_{j} , {v}_{j} ] ; {t}_{j}^{′} + {z}_{j}^{′} ) & ( 18 ) \\ & & & \end{matrix}$$

Specifically, πⱼ^{zkpok} prevents icmⱼ from maliciously committing to (pidⱼ, 0, δⱼ) with δⱼ≠0 which, when combining it with vcmⱼ, would yield a malicious ccmⱼ with a larger value vⱼ+δⱼ than what the range proof was over.

The bank 120 learns nothing about the recipient's (pidⱼ, vⱼ). Furthermore, even though the bank 120 knows the snⱼ's of these new coins, it will not be able to link them to their nullifiers when the coins are later spent. Lastly, the bank 120 signs each coin as σⱼ←RS.Sign(bsk, ccmⱼ; uⱼ), where uⱼ←$ [symbol] p and updates tx on the ledger with its σⱼ's.

To receive payments, Bob's client device 110 (e.g., via wallet application 115) has to scan the bank's transaction list for new transactions that he missed and check if those transactions paid him. For each new transaction tx (as per Eq. 13) and for each output j in tx, Bob checks if ctxtⱼ is encrypted for him via IBE.Dec(dsk, ctxtⱼ)≠⊥, where dsk is his decryption secret key. If so, Bob decrypts his (vⱼ, t′ⱼ, z′ⱼ) from Eq. 12, recomputes his output's snⱼ←Hsn(tx∥j) and reconstructs his coin commitment ccmⱼ←CM.Com([pidⱼ, snⱼ, vⱼ]; t′ⱼ+z′ⱼ). Next, he fetches the coin signature σⱼ from the TXN, rerandomizes (ccmⱼ, σⱼ) and adds it to his wallet 115.

Each user gets B budget coins per month, which allow them to send up to B normal coins every month blindly, without revealing any transaction details to the bank 120 or the auditor 130. A budget coin resembles a normal coin, except it has an expiration date expᵢ and is signed using the auditor's ask. For example, at the beginning of the month, a user provably reveals their pid to the auditor 130 using their registration credential (and a ZKPoK). The auditor 130 then issues them their monthly budget coin:

$$ccm = CM . Com ( [ pid , sn , B , expi ] ; r ) , where ( sn , r ) ← {\$ℤ}_{p}^{2} \qquad ( 19 )$$

$$σ = RS . Sign ( ask , ccm )$$

Note that the auditor 130 can easily encrypt the coin secrets for the user via IBE.Enc(mpk, pid, (sn, r)). For example, if the pid is an email address (or a phone number), this ciphertext can be emailed (or texted) to the user. By default, normal coins are now committed with expiration date set to 0.

Assume Alice has her budget coin ccm₃=CM.Com([pid_{A}, sn₃, v₃, expi]; r₃) and its signature σ₃, as per Eq. 19. The “2-to-2” transactions are modified as follows. First, Alice's client device 110 provides her budget coin (ccm₃, σ₃) as a third input to the TXN and argues in zero-knowledge that (1) its value v₃ exceeds the value v_{B} sent to Bob and (2) it is not expired. Second, Alice's client device 110 creates a third output (denoted by C) for the bank 120 to issue her budget change v_{c}=v₃−v_{B}. To validate the transaction, the bank 120 proceeds, nullifying all input coins, including the budget, and issuing coins as before, including Alice's budget change. (Recall that the bank 120 also knows ask.) Our new “3-to-3” anonymous-and-accountable transaction format is:

$${tx}_{acc} = \{ \begin{matrix}( rcm , rs ) , {π}^{budget} , expi \\ {〈 ( {ccm}_{i} , {σ}_{i} ) , {vcm}_{i} , {nullif}_{i} , {π}_{i}^{split} 〉}_{i ∈ [ 3 ]} \\ {〈 {icm}_{j} , {π}_{j}^{zkpok} , {vcm}_{j} , {π}_{j}^{range} , {ctxt}_{j} 〉}_{j ∈ \{ A , B , C \}}\end{matrix} \qquad ( 20 )$$

Step 1: Proving budget suffices-Alice's client device 110 must prove in zero-knowledge that (1) she gave enough budget v₃≥v_{B} and (2) that her budget change is exactly v_{C}=v₃−v_{B}. First, Alice correlates the randomness of the value commitments to satisfy not only z₁+z₂=z′_{A}+z′_{B}, but also z₃=z′_{C}+z′_{B}. This way, similar to Eq. 14, the bank can verify correctness of the budget change via vcm₃=vcm_{C}·vcm_{B} ↔v₃ ≡v_{c}+v_{B} (mod p). Second, Alice includes a range proof π_{C}^{range} which argues that v_{C} ∈[0, 2^{N}). As a result, it follows that v₃≥v_{B}.

Step 2: To verify the expi of the budget coin, Alice actually computes ccm₃ by using 0 as the expiration date and proves this using a Σ-protocol. Note this is compatible with the split relation from Eq. 8, which implicitly only accepts coins with expiration date 0. Next, the bank 120 can homomorphically add in the actual expiration date from the transaction and check the signature verifies via RS.Ver(apk, ccm₃.CM.Com([0, 0, 0, expi]; 0)).

Step 3: The above assumes Alice's client device 110 correctly generates the TXN to (1) pay Bob and (2) give herself normal change v_{A} as well as budget change v_{C}. However, a malicious Alice might craft the transaction to send the budget change to another user altogether, or to use her change output, which is not subject to budgeting, to pay yet another user. This is prevented using a budget proof π^{budget} which argues that Alice used her own pid_{A} (from rcm) in her icm_{A} and icm_{C} identity commitments, which should only be used to give herself change. In other words, Alice proves that the following relation R_{budget}(rcm, icm_{A}, icm_{C}; pid_{A}, s_{A}, a, t′_{A}, t′_{C}) holds:

$$( \begin{matrix}rcm = CM . Com ( [ {pid}_{A} , {s}_{A} ] ; a ) ∧ \\ {icm}_{A} = CM . Com ( [ {pid}_{A} , 0 , 0 , 0 ] ; {t}_{A}^{′} ) ∧ \\ {icm}_{C} = CM . Com ( [ {pid}_{A} , 0 , 0 , 0 ] ; {t}_{C}^{′} )\end{matrix} ) \qquad ( 21 )$$

Alice should still be able to split her own coins of value v₁ and v₂ into new coins of value v′₁ and v′₂, without spending any of her anonymity budget. For this, 2-to-2 transactions are allowed as per Eq. 13, but only if they come with a budget proof π^{budget} that argues all inputs and outputs have the same pid: i.e., that R_{budget}(rcm, icm_{A}, icm_{B}) holds. Note that an adversary can distinguish between transactions that split coins and transaction that actually spend them using budget.

In the rare case that Alice runs out of budget, she creates a 2-to-2 unaccountable transaction as per Eq. 13 which she clears with the auditor 130. Based on a customizable auditing policy, the auditor 130 can ask Alice's client device 110 to reveal various transaction details. This could range anywhere from provably-revealing everything to the auditor 130 or revealing nothing but the fact that the payment is a donation to a charity. For now, we assume Alice reveals everything to the auditor 130. The auditor 130 can simply sign the transaction to signal to the bank 120 that it has been audited and can be accepted on the ledger 125.

To deal with an actively-malicious bank 120, registration authority 140, or auditor 130, they are decentralized as a Byzantine fault-tolerant (BFT) state machine replication (SMIR) system of n=3f+1 servers, which guarantees safety in a partially-synchronous model. (Separate BFT systems for each actor can used, but we avoid this for ease of exposition in this discussion.) Every server i∈[n] will store shares (bskᵢ, rskᵢ, askᵢ, mskᵢ) of the bsk, rsk, ask and msk, respectively. Furthermore, honest servers will have a consistent view of the nullifier list and the valid transaction ledger. Servers must now collaborate to produce an f+1 out of n threshold signature on a coin (or registration commitment), or to issue an encryption SK to a user. This way, no subset of ≤f servers can maliciously issue new coins, register fake users or decrypt user's transactions.

We dual commit to coins using Pedersen as:

$$\begin{matrix}( ccm , ) & = & CM . {Com}_{cck} ( [ pid , sn , v , expi ] ; r ) & ( 25 ) \\ & {=}^{def} & ( {g}_{1}^{pid} {g}_{2}^{sn} {g}_{3}^{v} {g}_{4}^{expi} {g}^{r} , {\tilde{g}}_{1}^{pid} {\tilde{g}}_{2}^{sn} {\tilde{g}}_{3}^{v} {\tilde{g}}_{4}^{expi} {\tilde{g}}^{r} ) & ( 26 ) \\ & & & \end{matrix}$$

Here, cck [symbol] (cck₁, cck₂)=(g, (g₁, . . . , g₄), \tilde{g}, (\tilde{g}₁, . . . , \tilde{g}₄)) is our coin commitment key. Registration commitments (rcm, [symbol] ) are also dual, but under a related registration commitment key rck [symbol] (rck₁, rck₂)=(g, (g₁, g₅), \tilde{g}, (\tilde{g}₁, \tilde{g}₅)). Input value commitments in a TXN are computed only in [symbol] ₁ as vcmᵢ=CM.Com_{cck1}([0, 0, vᵢ, 0]; zᵢ). We defer discussion of output identity and value commitments, which will be closely tied to the threshold PS (Pointcheval-Sanders) signatures.

The bank 120 will sign coin and registration commitments using a threshold PS scheme. This slightly affects our TXN format, as illustrated in Eq. 29 (that follows), as well as how the bank 120 validates and processes TXNs.

For PS verification to work, any signed commitment in our TXN from Eq. 20 must be dual. Thus, [symbol] ∈G₂ is included next to rcm and, for each input ccmᵢ∈G₁, its corresponding [symbol] ∈G₂ is included. When receiving a payment, users must now fetch individual signature shares from the bank 120 and aggregate them via RS.Aggregate. (Alternatively, the bank 120 can aggregate the signature for the user and the user need only unblind it.)

Recall that the threshold PS variant requires pre-agreed randomness hⱼ for threshold signing the jth output coin commitment ccmⱼ from Eq. 17. For this, both Alice's client device 110 and the bank 120 pseudo-randomly compute a unique hⱼ←Hₚₛ(j∥(nullifᵢ)_{i∈[3]}) based on the input coin nullifiers in the transaction, where Hₚₛ is a CRHF.

For the bank to threshold sign, Alice must separately commit to the fields of each output coin j under a signature-specific commitment key tckⱼ=(hⱼ g). Since the bank 120 already knows the snⱼ's and the budget coin's expiration date, this could be as simple as Alice's client device 110 recomputing icmⱼ and vcmⱼ under tckⱼ. While Alice can do so for icmⱼ, using a different commitment key for vcmⱼ would break the value preservation checks from Eq. 14.

Instead, Alice leaves vcmⱼ as per Eq. 11 but computes an additional vcm*j←CM.Com_{tckj} (vⱼ; d′ⱼ), d′ⱼ←$ [symbol] ₚ and proves using a ZK proof πⱼ^{pedeq} that vcm*ⱼ commits to the same value as vcmⱼ. Importantly, Alice now encrypts d′ⱼ for each recipient in ctxtⱼ←IBE.Enc(mpk, pid, (vⱼ, d′ⱼ, t′ⱼ)), where t′ⱼ is the randomness of icmⱼ.

To threshold sign registration credentials for a user with pid, the user's rcm₁ commitment from Eq. 2 must also be computed under a signature-specific commitment key (h_{pid}, g), where h_{pid} is pre-agreed upon between the user and the RA. This is easy to achieve by letting h_{pid} be the hash of pid and the current time of the day. Then, the RA can threshold sign rcm from Eq. 2. Similarly, when issuing each user's monthly budget coin, the auditor 130 needs to threshold sign it as well. Once again, the randomness for this signature can be agreed to be the hash of pid and the current month.

In various embodiments, a well-known pseudo-random function by Dodis and Yampolskiy is used to compute nullifiers as nullif=PRFₛ(sn)=h^{1/(s+sn)}, where h←$ [symbol] ₁ is a fixed PRF public parameter. A main challenge is to efficiently prove correctness of nullif in ZK as part of the Rsplit relation from Eq. 8. For this, we include some auxiliary information:

$$v k = {\tilde{h}}^{s + s n} {\tilde{ω}}^{t} y = {e ( \tilde{nullif , \tilde{ω}} )}^{t} \qquad ( 24 )$$

Here, t is secret randomness from [symbol] ₚ and (\tilde{h},\tilde{ω})←$ [symbol] ₂² are also fixed PRF public parameters. Assuming correctness of vk and y, the bank 120 can check the correctness of the PRF as:

$$e ( nullif , vk ) {=}^{?} e ( nullif , {\tilde{h}}^{s + sn} {\tilde{w}}^{t} ) = \qquad ( 25 )$$

$$= e ( nullif , {\tilde{h}}^{s + sn} ) \cdot e ( nullif , {\tilde{w}}^{t} ) \qquad ( 26 )$$

$$= e ( {h}^{\frac{1}{s + sn}} , {\tilde{h}}^{s + sn} ) \cdot y {=}^{?} e ( h , \tilde{h} ) \cdot y \qquad ( 27 )$$

To prove the original Rsplit holds as per Eq. 8, the TXN creator first computes vk and y as per Eq. 24 and uses a Σ-protocol to prove the following inner split relation Rₛₚₗᵢₜ*(ccm, rcm, nullif, vcm, vk, y; pid, sn, v, r, s, a, z, t) holds:

$$( \begin{matrix}ccm = CM . {Com}_{{cck}_{1}} ( [ pid , sn , v ] ; r ) = {g}_{1}^{pid} {g}_{2}^{sn} {g}_{3}^{v} {g}^{r} & ∧ \\ rcm = CM . {Com}_{{rck}_{1}} ( [ pid , s ] ; a ) = {g}_{1}^{pid} {g}_{5}^{s} {g}^{a} & ∧ \\ & ∧ \\ vcm = CM . {Com}_{{cck}_{1}} ( [ 0 , 0 , v ] ; z ) = {g}_{3}^{v} {g}^{z} & ∧ \\ vk = {\tilde{h}}^{s + sn} {\tilde{w}}^{t} ∧ y = {e ( nullif , \tilde{w} )}^{t} & \end{matrix} ) \qquad ( 28 )$$

The splitproof π^{split} for the original Rsplit will consist of (vk, y) and the proof for this inner Rₛₚₗᵢₜ*, which no longer (directly) argues about correctness of nullif (crossed out above). The Rsplit verifier will first check (nullif, vk, y) as per Eq. 25 and then verify the proof for the inner Rₛₚₗᵢₜ* relation above.

The X-protocol for the inner Rₛₚₗᵢₜ* is made non-interactive via the Fiat-Shamir transform. This allows the TXN creator to implicitly sign the TXN when computing splitproofs, by simply hashing the TXN outputs when computing the challenge in the Fiat-Shamir transform.

We often have to prove knowledge of commitment openings or equality of certain committed values, which is done using well-known E-protocols. The final transaction format is:

$${tx}_{acc} = \{ \begin{matrix}( rcm , , rs ) , {π}^{budget} , expi \\ 〈 ( ccm , {i}_{} , {σ}_{i} ) , {vcm}_{i} , {π}_{i}^{split} 〉 i ∈ [ 3 ] \\ 〈 {icm}_{j} , {π}_{j}^{zkpok} , {vcm}_{j} , {vcm}_{j}^{*} , {π}_{j}^{pedeq} , {π}_{j}^{range} , {ctxt}_{j} 〉 j ∈ \{ A , B , C \}\end{matrix} \qquad ( 29 )$$

A natural approach to decentralize the bank is via generic Secure Multiparty Computation (MPC), however this generic approach would be rather costly. A highly optimized approach is used by observing that the UTT transaction can be split into 3 parts: (1) verification of the transaction (this is pure function); (2) atomic verification that the nullifiers are new and then adding them to the nullifier list; and (3) signing the outgoing coins.

Parts one and two require no secrets and hence can be implemented as a public ledger (essentially a Byzantine Fault Tolerant storage). Only Part three requires secrets to securely sign the outgoing coins (after the transaction is validated and verified atomically for no double spend). This part is designed via an efficient threshold cryptography scheme. When designed naively, it requires to serially execute all transactions and hence does not scale well. In order to make better use of multi-core servers, methods from Optimistic Concurrency Control approaches that are tailored to the malicious setting are used. In particular, we observe that it is possibly to optimistically run part one (the verification of the transaction) in parallel, before consensus, and only execution part two (atomic verification of no double spend of nullifiers) after consensus.

In order to better utilize modern multi-core architectures and the inherent parallelism of disjoint UTT transactions, various embodiments of an aDAP system 100 utilize a method for Byzantine Fault Tolerant Optimistic Concurrency Control which we call pre-execution. Instead of sending UTT transaction directly for consensus, the primary sends them to the servers of the distributed ledger network 125 for pre-execution. Each server (optimistically) pre-executes each UTT transaction by checking its cryptographic validity and (optimistically) checking that its nullifiers are not already present in the nullifier list. If the check succeeds, the server creates a read set and a write set that equals to the new nullifiers, and sends a signed message back to the primary with this read write set and the hash of the transaction. Once the primary receives f+1 signed messages of the same read and write set and the hash of the transaction, it adds this cryptographic proof to the block that goes for consensus. After a block passes consensus, it gets sent for execution. During execution, each server serially checks each read-write set in its block for conflicts (so there is no double spends) and checks that there are f+1 signatures for this hash of the transaction (so the transaction is valid). If there are no conflicts and the transaction is valid then the server signs its part of transaction's outgoing coins and adds the nullifiers to its nullifier list.

This Byzantine Fault Tolerant Optimistic Concurrency Control via Pre-execution provides important benefits: (i) it allows UTT transactions to be verified in parallel (allowing to take advantage of modern multi-core servers), and (ii) it removes expensive cryptography verification from the critical path of the serial execution stage after consensus.

In various embodiments, an alternative design is implemented where the bank is decentralized using Byzantine Consistent Broadcast and threshold cryptography. Much like other token based payment schemes, the consensus number of a UTT coin is one (only the payer can make operations on its coin) and there is no need to totally order transactions from different payers.

In this design, the payer 110 sends the transaction directly to all the servers. Each server simply process the transactions it receives locally: it checks that the transaction is valid and that the coins are not spent (their nullifiers are not in the nullifier list). If these checks pass, it sends the partial threshold signature of the new coins to the clients 110 and adds the new nullifiers to the nullifier list. Reading and writing to the nullifier list is done atomically. The threshold signature is set to require at least n-f signatures.

Once the client 110 accumulate n-f signatures, it has a cryptographic proof that indicates that the incoming coins are spent by at least n-2t honest servers hence no other way of spending these coins can obtain n-f signatures (due to quorum intersection). In addition, since the outgoing coins are signed, the payee can immediately use them. We also want to persist the outgoing coins at the servers in order to provide data availability, which is the ability of any party to read the signed outgoing coins. The user sends the signed transaction back to the servers and waits for n-f confirmations that the servers stored it. When a server received a signed transaction, it locally stores it and returns and acknowledgment back. Once the user receives n-f acknowledgements, it has a cryptographic proof that the signed transaction is available: anyone can query the servers and by waiting for just n-f responses will receive at least one honest server with the signed transaction (due to quorum intersection).

Note that Byzantine Consistent Broadcast is inherently parallel. The only sequential (atomic) part is when checking the nullifier list for double spend. In terms of latency, the BFT SMR approach requires waiting for a block of commands and needs additional round trips for consensus. Hence, we expect the BCB approach to have better latency. On the other hand, BCB does not provide total ordering and may add challenges to cross-server backup-and-restore procedures and for smart contracts that need total ordering.

As in many other fault tolerant protocols, it is possible to have a fast path which reduces latency and message complexity in the optimistic case where all servers are non-faulty and the system is synchronous. For Byzantine Consistent Broadcast, we observe that obtaining n-out-of-n signatures from the first round (instead of just n-f-out-of-n) guarantees data availability without needing an additional round: any later read will eventually see n-f responses for the same signed transaction. Similar to a SBFT (Scalable Byzantine-Fault Tolerance) environment, various embodiments use a fast path single-round BCB and wait for n responses with a timeout to revert to the regular two round protocol that waits for n-f responses each round.

The previous sections described two ways to decentralize a single logical bank 120. In many cases one would want to scale beyond just one bank, by partitioning the bank into several bank shards. The high level idea is that logically each bank shard will be responsible for a different part of the nullifier space. This will allow for an increase throughput by adding more bank shards. Operationally, to obtain decentralized trust, each bank shard will be decentralized via a separate sub-system of multiple servers (each such sub-system has a disjoint set of servers implementing it). A key observation is that the UTT payment can be split into two separate phases: (i) burn phase, where the nullifiers are marked as spent and the transaction is verified, and (ii) mint phase, where new coins are signed.

Given a set of logical bank shards, various embodiments use a standard consistent hashing approach that deterministically map the space of a hash function on the nullifiers to the bank shards. Each bank shard is decentralized via a separate BCB system of 3f+1 servers, hence a system with k bank shards will need a total of k(3f+1) servers. All bank shards use the same secret signing key, but each sub-system secret shares this secret key independently in such a way that secrets shares from different sub-systems are completely independent. Thus, the security of the system is Maintained as long as for any sub-system the adversary does not control more than f severs out of the 3f+1 servers that are used to decentralize each sub-system.

Logically, a user first executes the burn phase by sending the transaction to all the bank shards that are responsible for the nullifiers in the transaction. Each such bank shard verifies the transaction and that the nullifiers it is responsible for have not been double spent and sends a signed hash of the transaction back to the user. Since UTT transaction have three incoming coins that need to be burned, this means the user client device 110 needs to communicate with at most three bank shards. The user can then execute the mint phase by sending the signed hash from all the bank shards responsible to the nullifiers in the transaction to any bank shard. The receiving bank shard checks that the signatures are valid and from the correct bank shards and signs the new outgoing coins. To improve load balancing, various embodiments force the mint phase to happen only on a designated shard (as a function of the hash of the transaction).

In order to decentralize the burn phase and mint phase of a UTT transaction, while the mint phase may need the full two-round Byzantine Consistent Broadcast (BCB) for non-equivocation and data availability, the burn phase only needs a proof of non-equivocation—there is no need to have a proof that the certificate of burn is available on each of the bank shards responsible for the burn, because this certificate will be made available on the shard that executes the mint phase during the mint phase.

Therefore, in various embodiments, the decentralized implementation can be optimized as follows. The mint phase is implemented using Byzantine Consistent Broadcast (BCB) with a fast path: for the first round of BCB each server in the minting bank shard locally checks that n-f servers from each of the sub-systems responsible for burning the incoming coins have indeed burned them, and then signs the outgoing coins with its threshold signature. If n responses are returned then the protocol is complete (fast path BCB). Otherwise the n-f signatures are persisted in the second round of BCB.

For the burn phase, users run a single round protocol (which we call Crusader Broadcast) waiting for n-f signatures. A server in the distributed ledger network 125 locally checks that the incoming coin's nullifier is indeed in its responsibility and is not in its nullifier list. It then sends back a signature of the transaction. So n-f such signatures guarantees that the coins that are in the responsibility of this sub-system cannot participate in any other transaction (because that requires n-f signatures which is impossible due to quorum intersection).

For the burn phase, the user sends a one round trip (Crusader Broadcast) to at most three sub-systems (in parallel) and once each of these sub-systems returns n-f signatures. Then, for the mint phase the user runs Byzantine Consistent Broadcast with a fast path, which requires two round trips (just one in the optimistic case). In total, each transaction requires three round trips (just two in the optimistic case) of latency and interacting with at most 4 different bank shards.

For evaluation purposes, we evaluate an exemplary open-source implementation of an accountable transaction in the BFT setting. We implemented our accountable transaction in a C++ library called libutt based on BN254 elliptic curve groups implemented in libff. Here, we microbenchmark libutt on Ubuntu 18.04 in the us-east-2 region of AWS on c5.4×large machines with 16 cores and 16 GiB RAM and summarize our results in Table 1 (below).

TABLE 1

| Name | Measurement |
|---|---|
| TXN size | 14.4 KiB |
| TXN creation | 55.5 ms |
| BCB TXN validation | 13.54 ms |
| Bank TXN validation | 31.58 ms |
| Check TXN is mine | 0.60 ms |
| Claim TXN | 4.21 ms |

We measured the size of transactions, the time to create a TXN for Alice, the time to validate a TXN by the BCB replicas (in “BCB TXN validation” in Table 1, the time for a bank replica to fully validate a TXN, the time for Bob to check if a transaction is paying him (i.e., “Check TXN is mine” in Table 1), and the time for Bob to actually decrypt his coin details from the TXN and aggregate his coin signature (i.e., “Claim TXN”). Not surprisingly, we observe that TXN validation is the biggest bottlenecks that will affect the throughput and latency of the system.

We also consider a BFT SMR bank of n=4 replicas and evaluate its throughput in terms of the number of transactions processed by the system (as measured on the replicas), and latency in terms of end-to-end transaction confirmation time as measured by the sender and recipient. During testing, we run our macrobenchmark on a c5.4×large machines (16 core, 16 GiB RAM). We use f=1 and n=3f+1 replicas for our BFT SMR bank, with one machine per replica connected via the standard AWS LAN and use an open source implementation of BFT called Concord BFT. We use RocksDB for replicas to store nullifier sets.

We use Concord BFT's pre-execution feature to vertically scale the validation. The replicas pre-execute the UTT transaction by checking its cryptographic validity, and checking if the nullifiers are already present in the state. If these checks fail, then all replicas reject the transaction, and the primary aborts the transaction. If the checks pass, then the primary includes them in the proposed blocks. On committing the transaction, the replicas check the state again to ensure that the nullifiers were not spent between the pre-execution and committing. If the check passes, the replicas add the nullifiers to their local databases. Pre-execution provides two important benefits: (i) it can be done in parallel, and (ii) it also removes expensive cryptography from the critical path of the consensus.

For analysis, it is noted that the client sends an UTT accountable transaction to the UTT replicas and waits for n-f=3 responses from the BFT replicas. At least n-2f=2 responses are guaranteed to be valid and can be used to recover the newly minted coins. Throughput at the primary in intervals (every Is) is measured and a histogram at each client and report the median end-to-end latency over 400 operations is maintained. We use an automated batching policy and observe an average batch sizes of 12 transactions per consensus unit. Manually increasing batch sizes past this point actually lowered throughput.

Table 2 (below) shows that a BFT bank can process about 12 transactions per second per core (extracted from second to last row with 32 clients). However, when measuring the average time to handle a transaction inside a BFT replica, we get 41±3 ms leading to theoretical maximum throughput of ≈400 tx/s. Instead, we observe an actual throughput of ≈187 tx/s We conclude that Concord BFT contributes an overhead of 56% (i.e., it only provide 44% computational resources to our application). We believe further tuning may improve the BFT throughput.

We macrobenchmark our sharded system on a more powerful c5d.metal (96 cores, 384 GB RAM) AWS machines and implemented a shard as n=4 BCB replicas and n=4 bank replicas. BCB replicas are implemented separately (not as Concord BFT replicas) but still rely on RocksDB for storing the nullifier set. Bank replicas are implemented using Concord BFT except without storage of nullifier sets. Since BCB replicas are only concerned with a transaction's nullifiers, they need only check the split-proofs that vouch for these nullifiers. In contrast, recall that only the receiver of the payment (Bob) and the BFT SMR bank replicas will need to fully check the TXN. This provides a 2.3× speed-up in practice as shown in Table 2.

TABLE 2

| # Clients | Throughput | Latency |
|---|---|---|
| 4 | 71.71 tx/s | 48.37 ms |
| 8 | 111.14 tx/s | 68.09 ms |
| 16 | 162.86 tx/s | 91.82 ms |
| 32 | 187.43 tx/s | 170.0 ms |
| 64 | 155.43 tx/s | 398.60 ms |

For analysis purposes, it is noted that clients generate transactions, but send each one to the BCB replicas responsible for nullifying and locking. Our benchmark measures only the time for the BCB replicas to nullify and sign the transaction. We summarize the results in Table 3 (below). This means the recipient knows he was paid but still has to go the bank to get his coin's signature.

TABLE 3

| # Shards | Throughput | Latency |
|---|---|---|
| 3 | 2,680 tx/s | 35 ms |
| 12 | 7,650 tx/s | 42 ms |
| 15 | 10,200 tx/s | 43 ms |

The throughput of each shard is dependent only on the number of transactions that mark that shard as the target in the transaction. The throughput scales linearly with the number of shards, since the load is uniform across the shards and there is no intershard communication. The latency depends on the slowest shard: occasionally, the same shard is responsible for burning multiple input coins which results in slightly larger latencies.

As explained above, Table 3 measures the throughput for nullifying and locking transactions. But, the BFT SMR bank still has to fully-validate and sign these locked transactions. Yet, we saw the bank's transaction throughput was around 187 tx/s with a latency of 170 ms. However, recall that the batch size for these numbers was 12 transactions per batch. We increased this batch size to 100 and we measured the average time for a BFT SMR replica to process it (i.e., execution). Here, we find in Table 4 (below) that the throughput per core increases to 28 tx/s, which is quite optimal given our transaction validation times from Table 1. This means that, via batch verification, the per-core throughput of the SMR system can match the per-core throughput of the BCB system.

TABLE 4

| | Verification | Throughput |
|---|---|---|
| Number of threads | Time* | per core^{†} |
| 1 | 3,540 ms | 28.24 tx/s |
| 8 | 467 ms | 28.75 tx/s |

The extensive experimental evidence shows that UTT in an exemplary aDAP system and method provides improved scalability and performance. UTT scales well both when implemented as a Byzantine Fault Tolerance State Machine Replication and when implemented using Byzantine Consistent Broadcast. UTT also show scalability in terms of (1) minimal overhead when increasing the number of faults (for f=1, 3, 5, 10); (2) near-linear vertical scalability in terms of increasing the number of cores per server; and (3) near-linear vertical scalability in terms of increasing the number of shards. Additional testing shows that a non-sharded system using n=4 servers each with 96 cores obtained a throughput of 903 transactions with accountable privacy per second, with a latency of 39 ms. For a sharded system using s=60 shards, where each shard has a 16 core server, a throughput of 11, 351 transactions with accountable privacy per second was obtained.

In brief, the present disclosure presents systems and methods for an accountable decentralized anonymous payment (aDAP) scheme for untraceable transactions (UTT) designed from simple cryptographic building blocks. To balance accountability and privacy, UTT relies on anonymity budgets: users can anonymously send payments, but only up to a limited amount of currency per month. Past this point, transactions can either be made public or subjected to customizable auditing rules. An exemplary implementation of the aDAP system/method can scale horizontally to tens of shards and provide thousands of payment confirmations per second with latencies of hundreds of milliseconds. Such UTT systems and methods can be used as a privacy enhancing layer for Central Bank Digital Currencies (CBDC) and private sector stablecoins. CBDC and stablecoins as part of trusted privacy preserving technologies.

The components described herein can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit.

The components described herein can be embodied in the form of hardware, as software components that are executable by hardware, or as a combination of software and hardware. If embodied as hardware, the components described herein can be implemented as a circuit or state machine that employs any suitable hardware technology. This hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as magnetic, optical, semiconductor, or other suitable media. Examples of a suitable computer-readable media include, but are not limited to, solid-state drives, magnetic drives, and flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All modifications and variations are intended to be included herein within the scope of this disclosure.

Therefore, the following is claimed:

1. A non-transitory computer-readable medium comprising machine-readable instructions, wherein the instructions, when executed by at least one processor, cause a computing device to at least:
store, in a digital wallet, a digital coin that has been signed by a bank computing device;
rerandomize the digital coin and a coin signature to produce a new version of the digital coin that is anonymous with respect to an owner of the digital coin;
send the new version of the digital coin to a recipient computing device;
compute a nullifier for the new version of the digital coin using a pseuodorandom function over a serial number of the digital coin;
send the nullifier for the new version of the digital coin to the bank computing device; and
provide the bank computing device a zero knowledge proof that a value of the nullifier for the new version of the digital coin is correct and is the same as a nullifier of the digital coin.

2. The non-transitory computer-readable medium of claim 1, wherein a value of the digital coin is limited to a monthly budget monitored by an auditor computing device.

3. The non-transitory computer-readable medium of claim 2, wherein the instructions, when executed by at least one processor, cause the computing device to receive a budget coin from the auditor computing device having a value equivalent to the monthly budget.

4. The non-transitory computer-readable medium of claim 1, wherein the bank computing device is part of a distributed ledger network.

5. The non-transitory computer-readable medium of claim 4, wherein the distributed ledger network comprises a Byzantine fault-tolerance network.

6. The non-transitory computer-readable medium of claim 1, wherein the instructions, when executed by at least one processor, cause the computing device to register a computing device with an auditor computing device as part of an identity verification process.

7. The non-transitory computer-readable medium of claim 1, wherein the instructions, when executed by at least one processor, cause the computing device to encrypt the new version of the digital coin using identity based encryption.

8. A system, comprising:
a computing device comprising at least one processor; and
a memory comprising machine-readable instructions, wherein the instructions, when executed by the at least one processor, cause the computing device to at least:
store, in a digital wallet, a digital coin that has been signed by a bank computing device;
rerandomize the digital coin and a coin signature to produce a new version of the digital coin that is anonymous with respect to an owner of the digital coin;
send the new version of the digital coin to a recipient computing device;
compute a nullifier for the new version of the digital coin using a pseuodorandom function over a serial number of the digital coin;
send the nullifier for the new version of the digital coin to the bank computing device; and
provide the bank computing device a zero knowledge proof that a value of the nullifier for the new version of the digital coin is correct and is the same as a nullifier of the digital coin.

9. The system of claim 8, wherein a value of the digital coin is limited to a monthly budget monitored by an auditor computing device.

10. The system of claim 9, wherein the instructions, when executed by at least one processor, cause the computing device to receive a budget coin from the auditor computing device having a value equivalent to the monthly budget.

11. The system of claim 8, wherein the bank computing device is part of a distributed ledger network.

12. The system of claim 11, wherein the distributed ledger network comprises a Byzantine fault-tolerance network.

13. The system of claim 8, wherein the instructions, when executed by at least one processor, cause the computing device to register the computing device with an auditor computing device as part of an identity verification process.

14. The system of claim 8, wherein the instructions, when executed by at least one processor, cause the computing device to encrypt the new version of the digital coin using identity based encryption.

15. A method comprising:
storing, in a digital wallet by a computing device, a digital coin that has been signed by a bank computing device;
rerandomizing, by the computing device, the digital coin and a coin signature to produce a new version of the digital coin that is anonymous with respect to an owner of the digital coin;
sending, by the computing device, the new version of the digital coin to a recipient computing device;
computing, by the computing device, a nullifier for the new version of the digital coin using a pseuodorandom function over a serial number of the digital coin;
sending, by the computing device, the nullifier for the new version of the digital coin to the bank computing device; and
providing the bank computing device, by the computing device, a zero knowledge proof that a value of the nullifier for the new version of the digital coin is correct and is the same as a nullifier of the digital coin.

16. The method of claim 15, wherein a value of the digital coin is limited to a monthly budget monitored by an auditor computing device.

17. The method of claim 16, further comprising receiving a budget coin from the auditor computing device having a value equivalent to the monthly budget.

18. The method of claim 15, wherein the bank computing device is part of a distributed ledger network.

19. The method of claim 18, wherein the distributed ledger network comprises a Byzantine fault-tolerance network.

20. The method of claim 15, further comprising registering the computing device with an auditor computing device as part of an identity verification process.
